(19) United States
(12) Patent Application Publication
(10) Pub. No.: US 2014/0146920 A1
(43) Pub. Date: May 29, 2014

(54) MIXER WITH IQ GAIN-PHASE CALIBRATION CIRCUIT

(71) Applicant: KEYSTONE SEMICONDUCTOR CORP., Hsinchu (TW)

(72) Inventors: Chung-Yun Chou, HSINCHU (TW); Chao-Tung Yang, HSINCHU (TW)

(73) Assignee: KEYSTONE SEMICONDUCTOR CORP., HSINCHU (TW)

(21) Appl. No.: 13/685,930

(22) Filed: Nov. 27, 2012

(51) Int. Cl. H04L 27/00

(52) U.S. Cl. CPC H04L 27/00
USPC 375/316

(57) ABSTRACT

A mixer with IQ gain-phase calibration circuit is provided, including an I-path input stage, a Q-path input stage, an I-path switching stage, a Q-path switching stage, and an output stage, wherein the output stage further includes a phase calibration module, and a gain calibration module. The I-path and Q-path input stages are to convert the input voltage signal to a current signal, and the I-path and Q-path switching stages are to perform computation on input signal from the input stages with local oscillation signal. The signals from the switching stages are then passed through the phase calibration module for phase calibration and then through the gain calibration module for gain calibration before outputting.

### FIELD OF THE INVENTION

The present invention generally relates to a mixer, and more specifically to a mixer with IQ gain-phase calibration circuit.

### BACKGROUND OF THE INVENTION

Low intermediate frequency (IF) circuit is nowadays commonly used in communication systems. FIG. 1 shows a schematic view of a conventional low-IF circuit. As shown in FIG. 1, the input signal received by antenna 101 in the low-IF circuit travels along two paths, namely, I path and Q path. The low-IF circuit needs accurate quadrature phases and balance amplitudes in I path and Q path because the unbalanced IQ signals will cause a so-called image problem which will reduce SNR. FIG. 2 is a plot of the relation between the phase imbalance and image rejection ratio (IRR), which is often indicated in dB. As shown in FIG. 2, to achieve a 45 dB in image rejection ratio, the amplitude imbalance between I and Q paths must be less than 0.1 dB and the phase mismatch between I and Q paths must be less than 0.2% Therefore, the calibration is required to achieve desirable perform for the low-IF.

FIG. 3 shows a schematic view of a conventional quadrature mixer. As shown in FIG. 3, the quadrature mixer includes an I-path mixer and a Q-path mixer. The I-path mixer and the Q-path mixer each includes an input stage 301, a switching stage 302 and an output stage 303. The input stage 301 is to convert the input voltage signal to a current signal, the switching stage 302 is to perform computation on input signal from the input stage 301 with local oscillation signal, and the output stage 303 is to convert the current signal to voltage signal for outputting. FIG. 4 shows a circuit diagram of an embodiment of the conventional quadrature mixer of FIG. 3.

### SUMMARY OF THE INVENTION

The primary object of the present invention is to provide a mixer with IQ gain-phase calibration circuit to achieve low image rejection ratio (IRR) as well as high signal-noise ratio (SNR).

To achieve the above object, the present invention provides a mixer with IQ gain-phase calibration circuit, including an I-path input stage, a Q-path input stage, an I-path switching stage, a Q-path switching stage, and an output stage, wherein the output stage further includes a phase calibration module, and a gain calibration module. The I-path and Q-path input stages are to convert the input voltage signal to a current signal, the I-path and Q-path switching stages are to perform computation on input signal from the input stages with local oscillation signal, in other words, mixing. The signals from the switching stages are then passed through the phase calibration module for phase calibration and then through the gain calibration module for gain calibration before outputting.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of a conventional low-IF circuit;

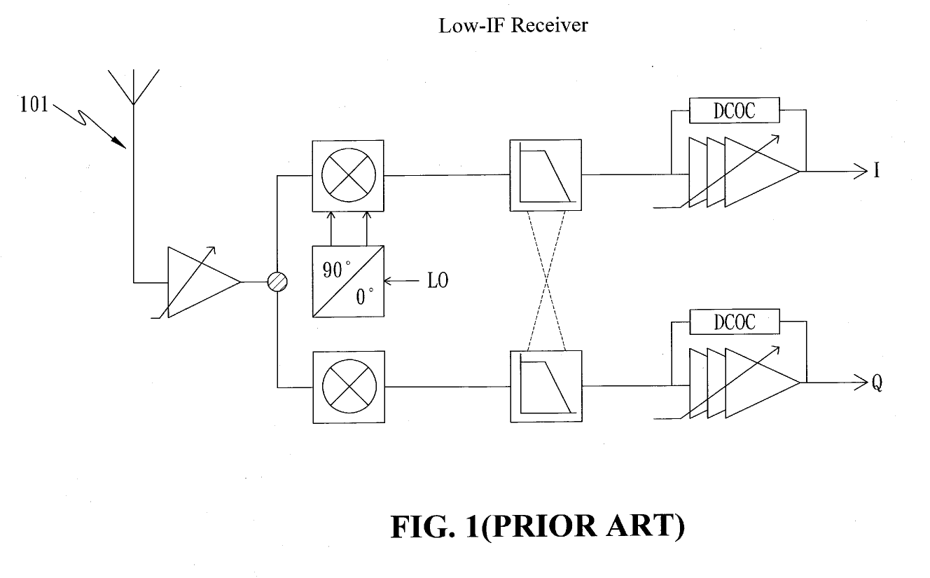

FIG. 2 is a plot of the relation between the phase imbalance and image rejection ratio (IRR);

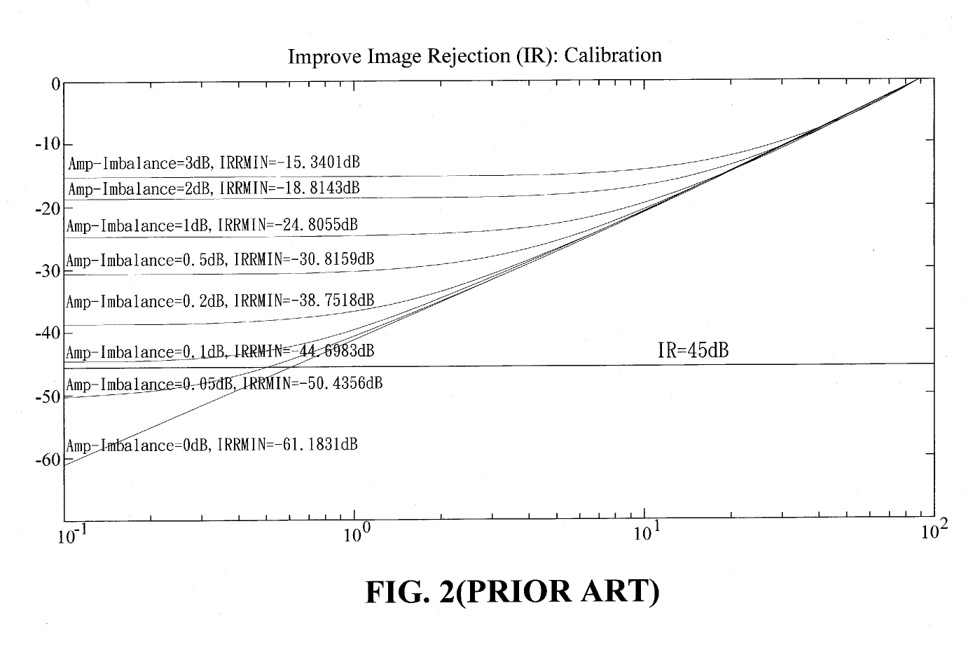

FIG. 3 shows a schematic view of a conventional quadrature mixer;

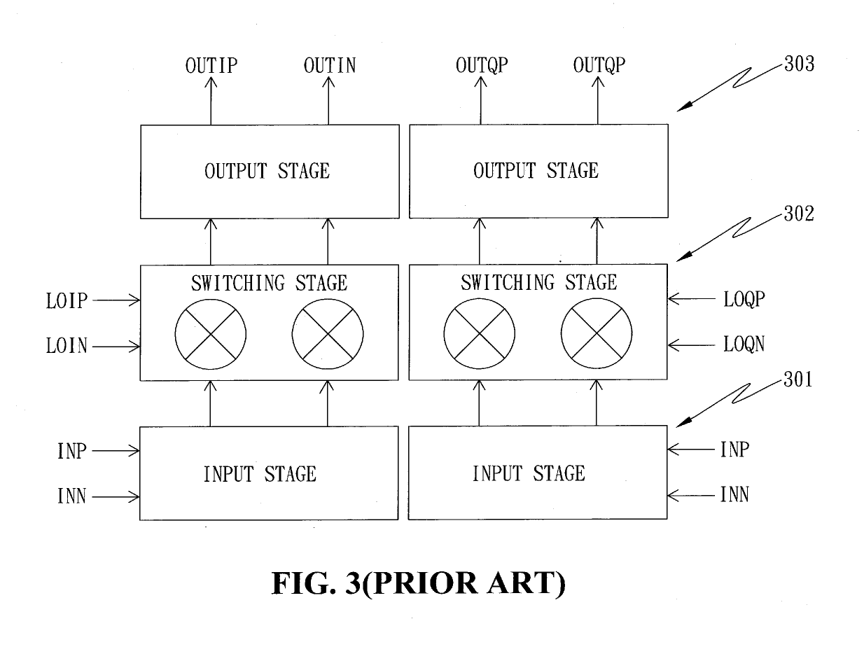

FIG. 4 shows a circuit diagram of an embodiment of the conventional quadrature mixer of FIG. 3;

FIG. 5 show schematic view of a calibration scenario of decomposing Q-path signal in a vector format;

FIG. 6 shows a schematic view of calibrating Q-path signal;

FIG. 7 show schematic view of a calibration scenario of decomposing I-path signal in a vector format;

FIG. 8 shows a schematic view of calibrating I-path signal;

FIG. 9 show schematic view of a calibration scenario of decomposing both I-path and Q-path signals in a vector format;

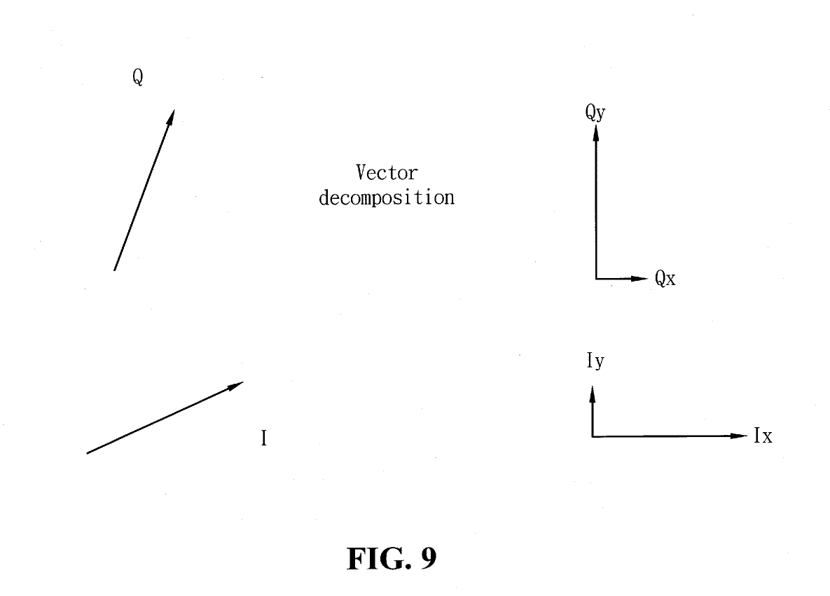

FIG. 10 shows a schematic view of calibrating both I-path and Q-path signals;

FIG. 11 shows a schematic view of a mixer with IQ gain-phase calibration circuit according to the present invention; and

FIG. 12 shows a circuit diagram of an actual embodiment of a mixer with IQ gain-phase calibration circuit according to the present invention.

### DETAILED DESCRIPTION OF THE PREFERRED EMBODIMENTS

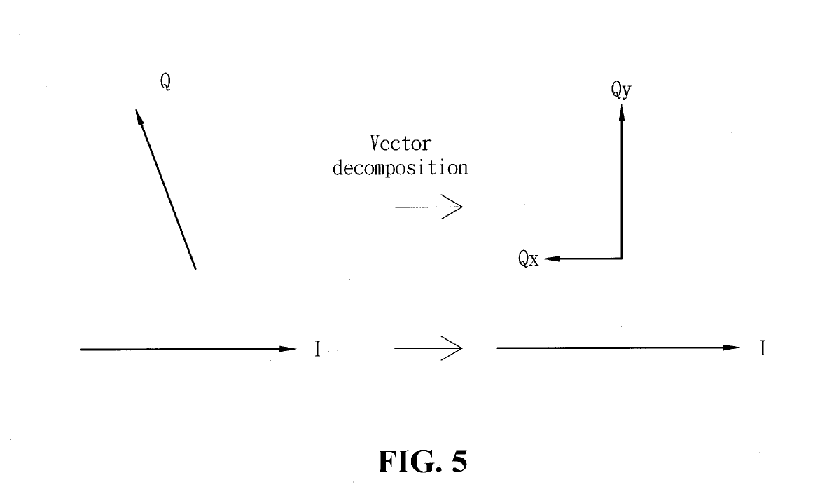

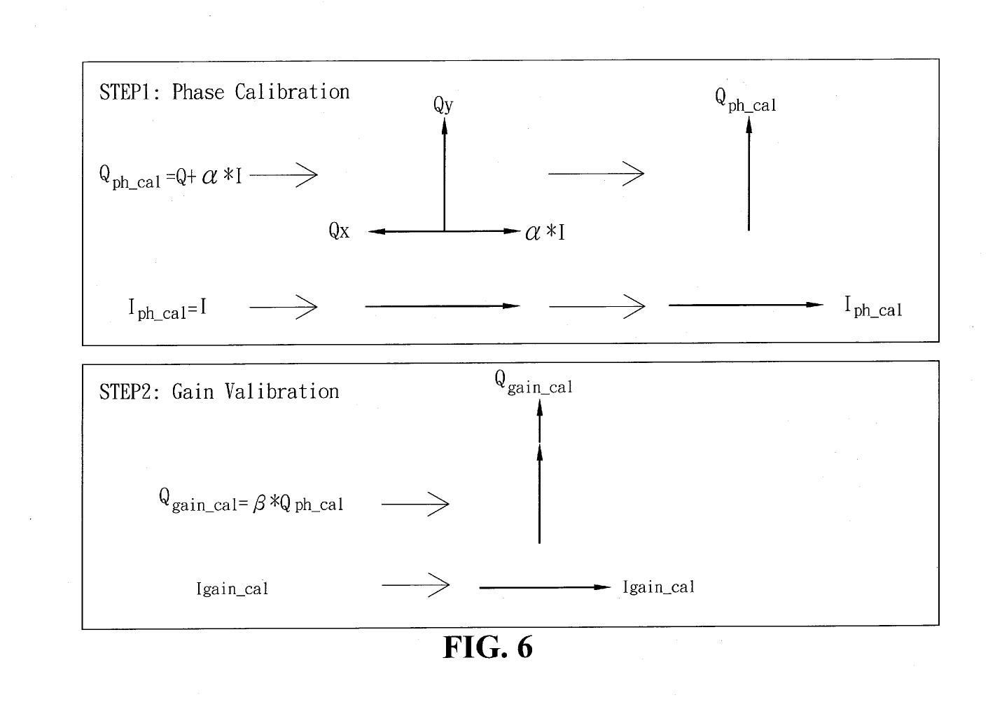

FIG. 5 and FIG. 6 show schematic views of a calibration scenario wherein the calibration on Q-path signal in a vector format for explanation. As shown in FIG. 5, the Q-path signal and the I-path signal are both depicted as vectors, the Q-path signal and the I-path signal have different maganitude and the phase difference between the Q-path signal and the I-path signal is not equal to 90°. The Q-path signal can be decomposed into two component vectors Qₓ, Q_{y}, wherein Qₓ is in the parallel direction as the I-path signal I, and Q_{y} is in the direction perpendicular, i.e., quadrature, to the direction of the I-path signal I. Refer to FIG. 6 for calibration computations. As shown in FIG. 6, to calibrate the phase, vector I is multiplied by a factor α to cancel out the Qₓ component vector. In other words, Qₚₕ_{_{—}}_{cal}=Q+α*I, wherein α*I and Qₓ are equal in size but of opposite direction. Thus, after phase calibration, the result Q phase vector Qₚₕ_{_{—}}_{cal} is equal to Q_{y}. Similarly, after gain calibration, the result Q amplitude vector Q_{gain}_{_{—}}_{cal} is equal to β*Qₚₕ_{_{—}}_{cal}. As the calibration is only performed on Q-path signal in his scenario, the I-path signal remains the same after calibration; that is, Iₚₕ_{_{—}}_{cal}=I, and I_{gain}_{_{—}}_{cal}=Iₚₕ_{_{—}}_{cal}.

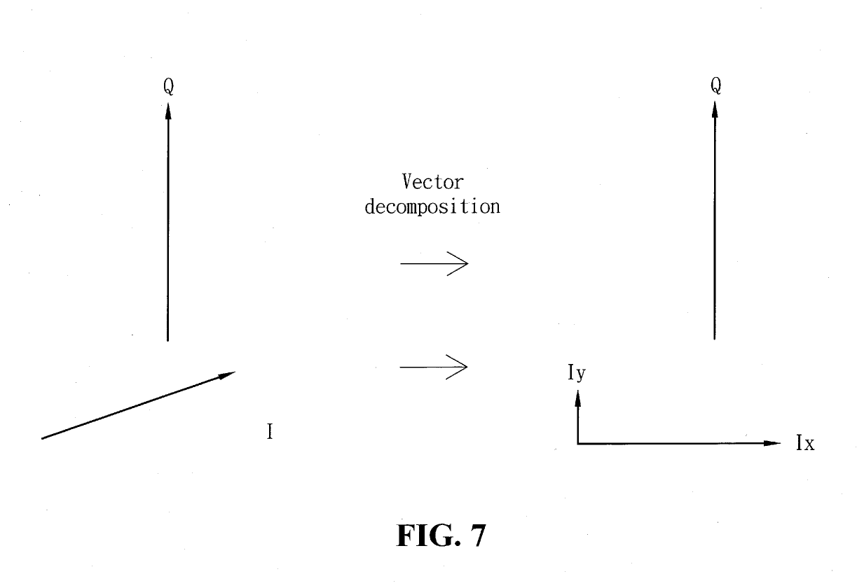

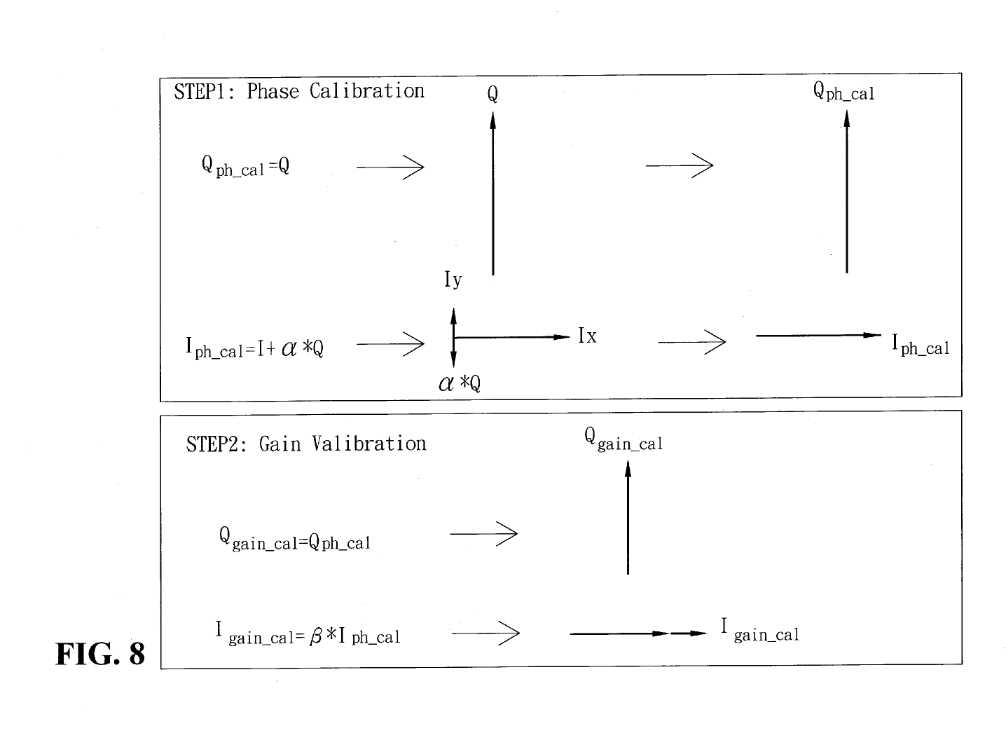

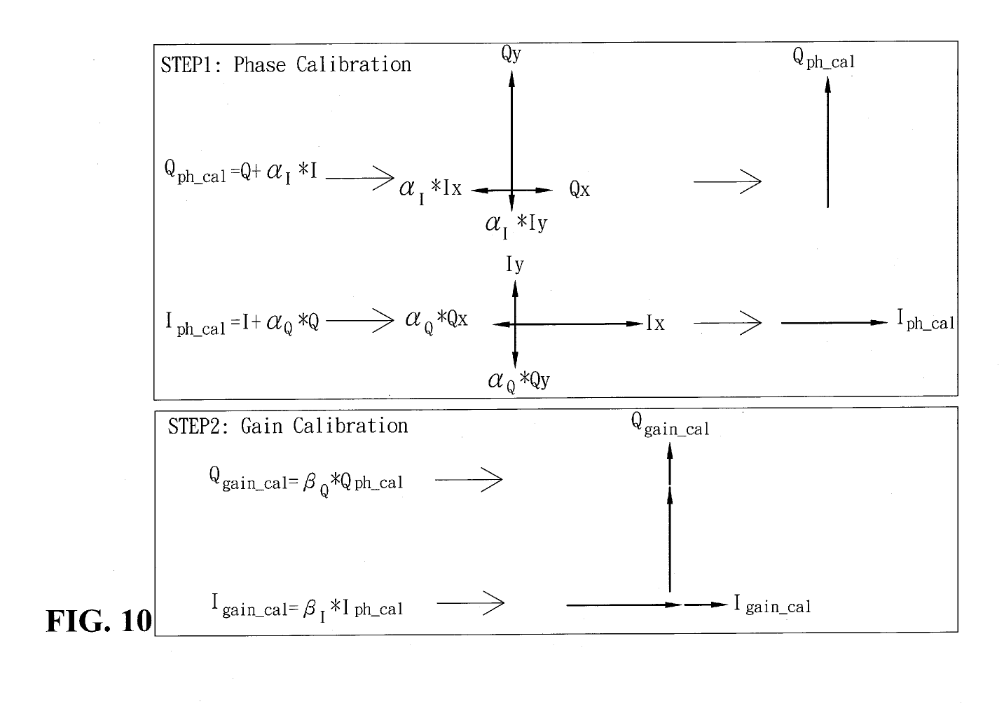

FIG. 7 and FIG. 8 show schematic views of a calibration scenario wherein the calibration on I-path signal in a vector format for explanation. This scenario is similar to the above scenario wherein the calibration is only performed on the Q-path signal, except that the calibration is now performed on the I-path signal. After calibration, the Q-path signal remains unchanged; that is, Qₚₕ_{_{—}}_{cal}=Q, and Q_{gain}_{_{—}}_{cal}=Qₚₕ_{_{—}}_{cal}, while the I-path signal is calibrated as: Iₚₕ_{_{—}}_{cal}=I+α*Q, and I_{gain}_{_{—}}_{cal}. calibration is performed on both I-path and Q-path signals. In this scenario, the vector I and vector Q are decomposed into component vectors Iₓ and I_{y}, and Qₓ and Q_{y}, respectively, wherein Iₓ and Qₓ are parallel in direction and I_{y} and Q_{y} are parallel in direction. The phase is first calibrated, that is, Qₚₕ_{_{—}}_{cal}=Q+α_{I}*I Iₚₕ_{_{—}}_{cal}=I+α_{Q}*Q. As shown in FIG. 10, the Qₓ component vector and the I_{y} component vector are cancelled out by the α_{I}*Iₓ and α_{Q}*Q_{y} respectively. Similarly, after gain calibration, the amplitudes of I-path and Q-path signals are Q_{gain}_{_{'}}_{cal}=β_{Q}*Qₚₕ_{_{—}}_{cal} and I_{gain}_{_{—}}_{cal}=β_{I}*Iₚₕ_{_{—}}_{cal}. respectively.

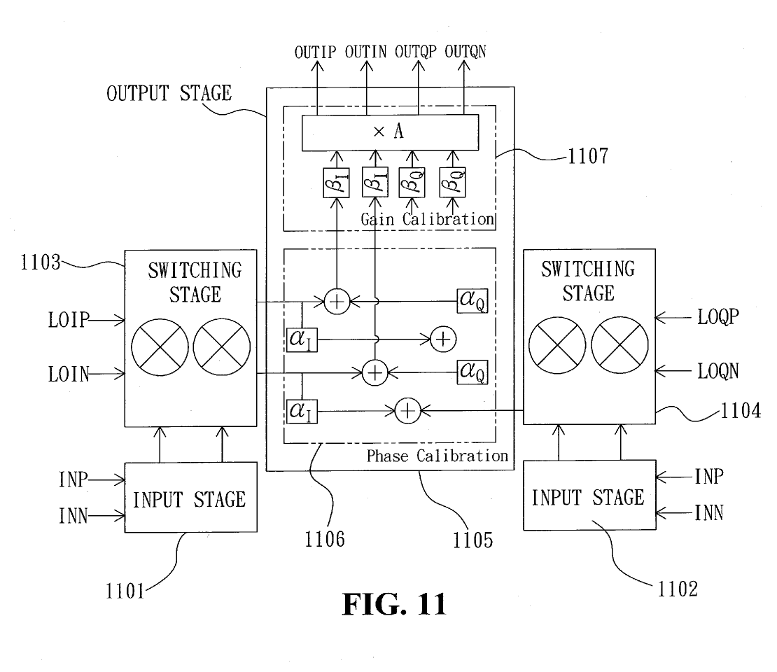

FIG. 11 shows a schematic view of a mixer with IQ gain-phase calibration circuit according to the present invention. As shown in FIG. 11, a mixer with IQ gain-phase calibration circuit of the present invention includes an I-path input stage 1101, a Q-path input stage 1102, an I-path switching stage 1103, a Q-path switching stage 1104, and an output stage 1105, wherein the output stage 1105 further includes a phase calibration module 1106, and a gain calibration module 1107. The I-path input stage 1101 receives input signals INP and INN and converts the input voltage signal to current signal. The I-path switching stage 1103 receives input control signals LOIN and LOIP, and is connected to the I-path input stage 1101 to receive the converted current signal and mix with built-in local oscillators. Similarly, the Q-path input stage 1102 receives input signals INP and INN and converts the input voltage signal to current signal. The Q-path switching stage 1104 receives input control signals LOQN and LOQP, and is connected to the Q-path input stage 1102 to receive the converted current signal and mix with built-in local oscillators. The respective mixed signals from I-path switching stage 1103 and Q-path switching stage 1104 are then passed to the phase calibration module 106. The phase calibration module 106 implements the computation of Qₚₕ_{_{—}}_{cal}=Q+α_{I}*I Iₚₕ_{_{—}}_{cal}=I+α_{Q}*Q, as described earlier. As shown in FIG. 11, the blocks marked with α₁ and α_{Q} indicate the multipliers which multiply the signals with the respective α_{I} and α_{Q}, and the circles marked with “+” sign indicate the adders which add two signals together. The results Iₚₕ_{_{—}}_{cal} and Qₚₕ_{_{—}}_{cal} from the phase calibration module 1106 are then passed to the gain calibration module 1107, which embodies the computation of Q_{gain}_{_{—}}_{cal}=β_{Q}*Qₚₕ_{_{—}}_{cal} and I_{gain}_{_{—}}_{cal}=β_{I}*Iₚₕ_{_{—}}_{cal} by multiplying the results with β_{I} and β_{Q}, respectively. The results of the multiplication are then further multiplied by a common gain factor A before final outputting.

It is worth noting that when α_{Q}=0, the calibration is performed on the Q-path signal only. Similarly, when α_{I}=0, the calibration is performed on the I-path signal only. When neither α_{I} nor α_{Q} is zero, the calibration is performed on both I-path and Q-path signals. Thus, the three different calibration scenarios described above are all covered by the present embodiment.

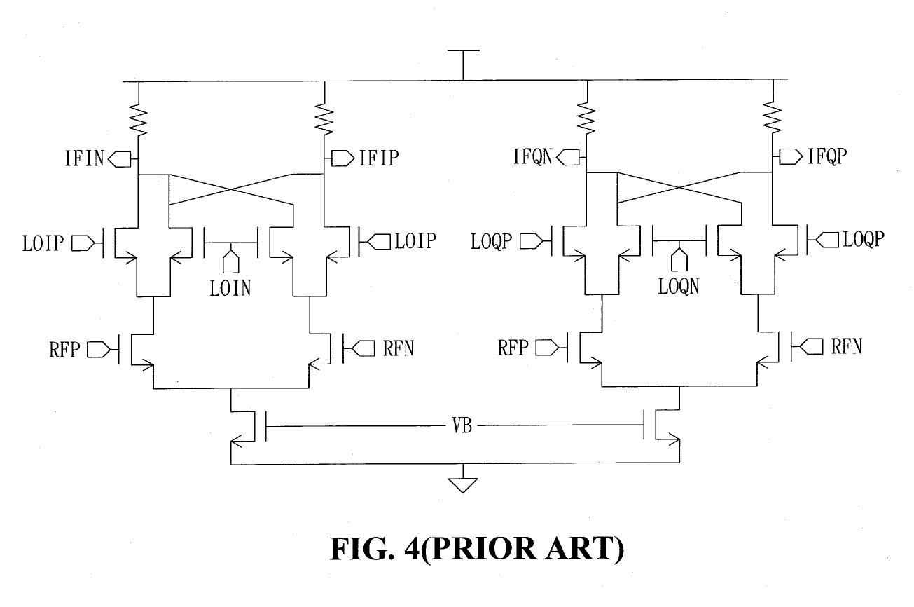

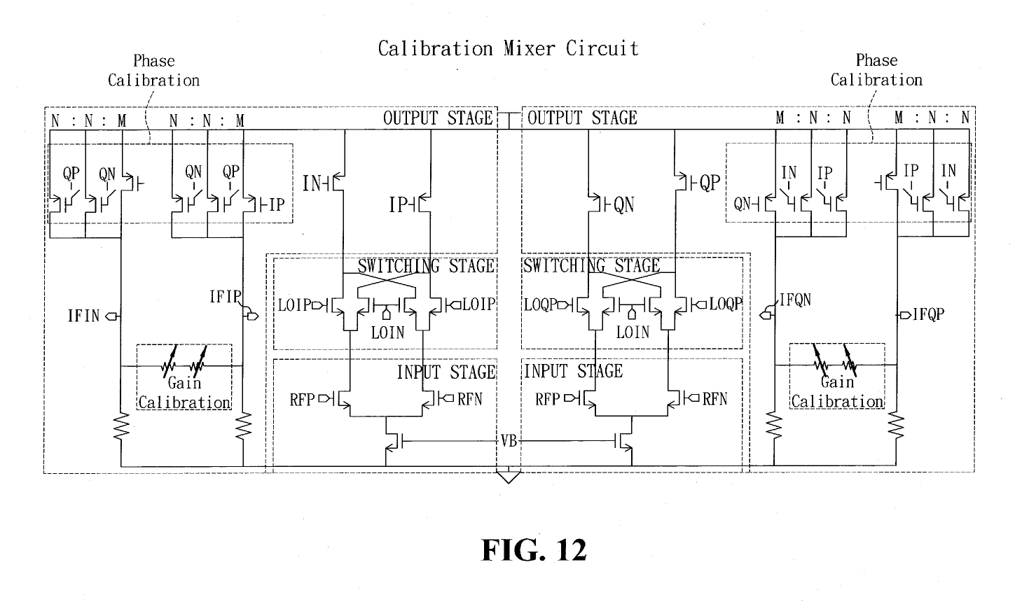

FIG. 12 shows a circuit diagram of an actual embodiment of a mixer with IQ gain-phase calibration circuit according to the present invention. As shown in FIG. 12, the circuit embodiment of input stage, switching stage, output stage, phase calibration module and gain calibration module are all marked. In comparison with the circuit diagram in FIG. 4, the phase calibration module and the gain calibration module are added to the conventional mixer of FIG. 4. It is also worth noting that the IQ can be implemented by switching current mirror and the gain calibration module can be implemented by switching resistor loads. As such, there is scarcely any reciprocal effect between the phase calibration and the gain calibration will occur. In addition, the calibration circuits operate at IF to avoid the parasitic effect at high frequency.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A mixer with IQ gain-phase calibration circuit, comprising:
an I-path input stage, for receiving input voltage signals and converting said input voltage signals to current signals;
a Q-path input stage, for receiving input voltage signals and converting said input voltage signals to current signals;
an I-path switching stage, connected to said I-path input stage to receive said converted current signal and mixing said converted current signal with built-in local oscillators;
a Q-path switching stage, connected to said Q-path input stage to receive said converted current signal and mixing said converted current signal with built-in local oscillators; and
an output stage, said output stage further comprising a phase calibration module and and a gain calibration module;
wherein said respective mixed signals from said I-path switching stage and said Q-path switching stage being then passed to said phase calibration module for phase calibration, and then through said gain calibration module for gain calibration.

2. The mixer with IQ gain-phase calibration circuit as claimed in claim 1, wherein said phase calibration module performs computation of Qₚₕ_{_{—}}_{cal}=Q+α_{I}*I Iₚₕ_{_{—}}_{cal}=I+α_{Q}*Q, where Iₚₕ_{_{—}}_{cal} and Qₚₕ_{_{—}}_{cal} are I and Q signals after phase calibration respectively, I and Q represent I and Q signals before phase calibration respectively, and α₁ and α_{Q} are factors selected to satisfy Qₓ=−α_{I}*Iₓ and I_{y}=−α_{Q}*Q_{y}, where Qₓ, Q_{y}, Iₓ, and I_{y} are component vectors of Q and I decomposed along two quadrature directions x and y, respectively,

3. The mixer with IQ gain-phase calibration circuit as claimed in claim 2, wherein said Iₚₕ_{_{—}}_{cal} and Qₚₕ_{_{—}}_{cal} resulted from said phase calibration module are passed to said gain calibration module, and said gain calibration module performs computation of Q_{gain}_{_{—}}_{cal}=β_{Q}*Qₚₕ_{_{—}}_{cal} and I_{gain}_{_{—}}_{cal}=β_{I}*Iₚₕ_{_{—}}_{cal}, where β_{I} and β_{Q} re selected factors, and then multiplies with a factor before outputting.

4. The mixer with IQ gain-phase calibration circuit as claimed in claim 1, wherein said phase calibration module and said gain calibration module are implemented at intermediate frequency avoid parasitic effect at high frequency.
